(19) United States
(12) Patent Application Publication
(10) Pub. No.: US 2004/0258493 A1
(43) Pub. Date: Dec. 23, 2004

(54) Tap having threaded portion coated with diamond-like carbon coating

(75) Inventors: Hiroto Sugano, Shinshiro-shi (JP); Yasuo Fukui, Hoi-gun (JP)

Correspondence Address: OLIFF & BERRIDGE, PLC, P.O. BOX 19928, ALEXANDRIA, VA, 22320, US

(73) Assignee: OSG CORPORATION, Toyokawa-shi (JP)

(21) Appl. No.: 10/678,217

(22) Filed: Oct. 6, 2003

(30) Foreign Application Priority Data
Jun. 19, 2003 (JP) 2003-174835

(51) Int. Cl. B27G 15/00

(52) U.S. Cl. 408/222

(57) ABSTRACT

A tap having a threaded portion which includes: a chamfered portion provided by an axially distal end portion of the tap; and a complete thread portion contiguous to the chamfer portion in an axial direction of the tap. A number of chamfered threads is not larger than 2.5 as counted along the axial direction. The threaded portion is coated with a diamond-like carbon coating which has a thickness of not larger than 0.4 μm.

### BACKGROUND OF THE INVENTION

1.Field of the Invention

This invention relates in general to a tap which is capable of satisfactorily cutting or forming an internal thread in an aluminum-based work material, with application of an air blow or an oil mist.

2.Discussion of the Related Art

There is widely known a straight-fluted, spiral-fluted or flute-less tap for cutting or forming an internal thread in a hole of a work material. The tap has a threaded portion including a complete thread portion and a chamfered portion which is provided by an axially distal end portion of the tap and which acts as a guide in starting the tap into the hole. As an example of the tap, JP-A-2002-292521 (publication of unexamined Japanese Patent Application laid open in 2002) discloses a tap in which the complete thread portion and the chamfered portion are coated at their surfaces with a diamond-like carbon coating (hereinafter referred to as “DLC coating”) having a thickness of 1-20μm. Owing to the DLC coating, this tap is capable of satisfactorily machining an internal thread even in a hard-to-cut material such as a metal matrix composite material (MMC). The DLC coating, having a fine amorphous structure and crystallographically different from a diamond, provides the tap with high degrees of hardness and wear resistance.

However, where the thread machining is effected on an easily fusible or weldable work material (such as aluminum-based work material) with substantially no lubricating oil or with a minimum quantity of lubricating oil, namely, with application of an air blow or an oil mist toward the tap, even the tap with the DLC coating suffers from a so-called “built-up edge” which is formed as a result of a deposit of chip material adhering to each cutting edge of the tap. The formation of the built-up edge leads to deterioration in an accuracy of the formed tap in an early stage of its service and accordingly reduces the tool life of the tap.

### SUMMARY OF THE INVENTION

The present invention was made in view of the background prior art discussed above. It is therefore a first object of the present invention to provide a tap having a satisfactorily long tool life even where the tap is used for machining an internal thread in an easily weldable work material with application of an air blow or an oil mist toward the tap. This first object may be achieved according to any one of first through fifth aspects of the invention which are described below. It is a second object of the invention to provide a process of forming an internal thread in an easily weldable work material, by using the tap having the technical advantage as described above. This second object may be achieved according to the sixth or seventh aspect of the invention which is described below.

The first aspect of this invention provides a tap having a threaded portion which includes: (a) a chamfered portion provided by an axially distal end portion of the tap; and (b) a complete thread portion contiguous to the chamfer portion in an axial direction of the tap, wherein a number of chamfered threads is not larger than 2.5 as counted along the axial direction, and wherein the threaded portion is coated with a diamond-like carbon coating which has a thickness of not larger than 0.4 μm.

According to the second aspect of the invention, the tap defined in the first aspect of the invention consists of a spiral-fluted tap having spiral flutes.

According to the third aspect of the invention, in the tap defined in the first or second aspect of the invention, the number of chamfered threads is 1.5-2.0 as counted in the axial direction.

According to the fourth aspect of the invention, in the tap defined in any one of the first through third aspects of the invention, the thickness of the diamond-like carbon coating is not smaller than 0.05 μm.

According to the fifth aspect of the invention, in the tap defined any one of the first through fourth aspects of the invention, the thickness of the diamond-like carbon coating is 0.1-0.3 μm.

The sixth aspect of the invention provides a process of machining an internal thread in a workpiece made of a material including aluminum, by using the tap defined in any one of the first through fifth aspects of the invention. The process comprises: a step of applying an air blow toward a machining point at which the workpiece is machined by the threaded portion of the tap, while at least one of the tap and the workpiece is rotated and moved relative to the other of the tap and the workpiece.

The seventh aspect of the invention provides a process of machining an internal thread in a workpiece made of a material including aluminum, by using the tap defined in any one of the first through fifth aspects of the invention. The process comprises: a step of applying an oil mist toward a machining point at which the workpiece is machined by the threaded portion of the tap, while at least one of the tap and the workpiece is rotated and moved relative to the other of the tap and the workpiece.

In the tap constructed according to the invention, the number of the chamfered threads (i.e., the number of the threads located in the chamfered portion) is so small as 2.5 or less as counted along the axial direction of the tap. It can be said that, in a machining of an internal thread with a tap, the internal thread is cut or formed by mainly its chamfered portion rather than its complete thread portion, which principally serves to finish the thread. Therefore, in a machining of an internal thread with the tap constructed according to the invention, since the chamfered portion of this tap has a relatively small area, the internal thread is cut or formed with the relatively small area being brought into contact with the work material.

Further, in the tap constructed according to the invention, the chamfered portion and the complete thread portion are coated with the DLC coating which has the thickness of not larger than 0.4 μm. The provision of the DLC coating, which has a small coefficient of friction, cooperates with the above-described arrangement in which the chamfered portion has the relatively small area, to prevent chip material from adhering to each cutting edge of the tap and accordingly extend the tool life, even where the tap is used for machining an internal thread in an easily weldable work material with application of an air blow containing no lubricating oil or with application of an oil mist containing a minimum quantity of lubricating oil.

The principle of the invention is advantageously applicable to a spiral-fluted tap as defined in the second aspect of the invention. However, it is applicable also to a straight-fluted and even to a flute-less tap. A tool substrate providing a body of the tap is preferably formed of cemented carbide or high speed tool steel.

The tap according to the invention is advantageously used in a dry or semi-dry machining in which the machining of an internal thread is effected with application of an air blow or an oil mist toward the tap. However, needless to say, the tap can be used also in a wet machining in which a large amount of lubricating oil is applied toward the tap.

In the process defined in the seventh aspect of the invention in which the machining of the internal thread is effected with a so-called “minimum quantity lubrication (MQL)”, a minimum quantity of lubricating oil taking the form of a mist is applied toward the machining point at which the work material is being machined by the tap, for example, under an air pressure of about 0.5 MPa, such that the mist is ejected from a nozzle (positioned near the machining point) at a flow rate of about 15 cc per hour.

In the tap according to the invention, the number of the chamfered threads is preferably 1.5-2.0. The thickness of the DLC coating is not larger than 0.4 μm, since the deposition of fused chip material on each cutting edge can not be satisfactorily prevented where the thickness of the DLC coating is larger than 0.4 μm. Further, it is preferable that the thickness of the DLC coating is not smaller than 0.05 μm, since the tap can not exhibit a sufficient degree of wear resistance where the thickness of the DLC coating is too small. It is more preferable that the thickness of the DLC coating is preferably 0.1-0.3 μm.

While the DLC coating is formed preferably in accordance with a plasma CVD method, the formation of the DLC coating can be made in accordance with other method such as an ion beam vapor deposition method and a CO₂ laser-induced discharge method.

The tap according to the invention can be advantageously used for machining an internal thread in an easily weldable work material such as an aluminum-based material (e.g., an aluminum alloy casting and an aluminum alloy die-casting). However, the tap according to the invention can be used for a thread machining effected on a steel material (e.g., stainless steel and carbon steel), a nonferrous metal and other metallic work material.

### BRIEF DESCRIPTION OF THE DRAWINGS

The above and other objects, features, advantages and technical and industrial significance of this invention will be better understood by reading the following detailed description of the presently preferred embodiment of the invention, when considered in connection with the accompanying drawings, in which:

FIG. 1A is a perspective view of a spiral-fluted tap constructed according to this invention;

FIG. 1B is a cross sectional view of a threaded portion of the spiral-fluted tap of FIG. 1A, taken in a plane perpendicular to an axis of the tap;

FIG. 2 is a view schematically illustrating a threading operation with the tap of FIG. 1A;

FIG. 3A is a table indicating specifications of taps used in a test conducted for seeing a relationship between the thickness of the DLC coating and the deposition of chip material on each cutting edge;

FIG. 3B is a table indicating a cutting condition in the above-described test;

FIG. 3C is a graph indicating a result of the above-described test;

FIG. 4A is a table indicating specifications of taps used in a test conducted for seeing a relationship between the number of the chamfered threads and the deposition of chip material on each cutting edge;

FIG. 4B is a table indicating a cutting condition in the above-described test;

FIG. 4C is a graph indicating a result of the above-described test;

FIG. 5A is a table indicating specifications of taps used in a test conducted for seeing a relationship between the kind of coating and the durability of each tap;

FIG. 5B is a table indicating a cutting condition in the above-described test; and

FIG. 5C is a graph indicating a result of the above-described test.

### DETAILED DESCRIPTION OF THE PREFERRED EMBODIMENTS

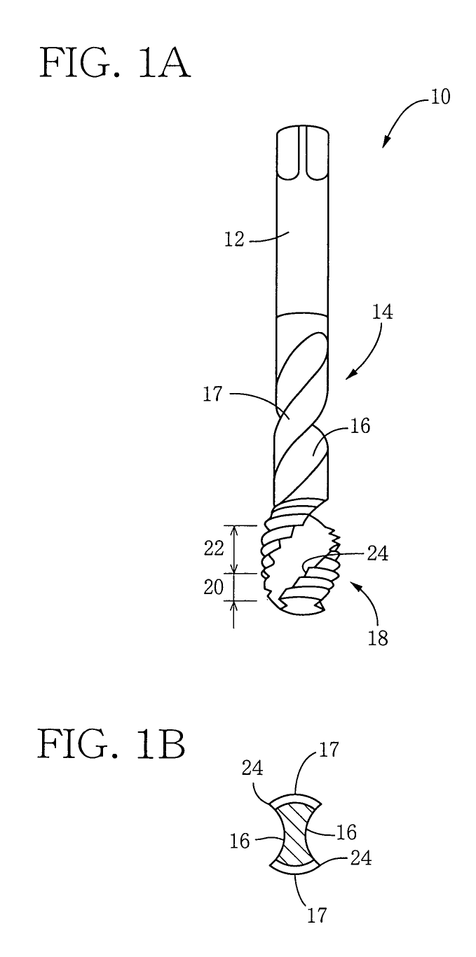

Referring first to FIGS. 1A and 1B, there will be described a spiral-fluted tap 10 which is constructed according to an embodiment of the invention. The tap 10 consists of a shank 12 and a fluted main body 14 which are coaxial with each other and formed integrally with each other. The fluted main body 14 has a pair of helical or spiral flutes 16 each extending from its axially distal end toward the shank 12, and a pair of lands 17 each provided by a peripheral portion of the fluted main body 14 not cut away by the flutes 16. An axially distal end portion of the fluted main body 14 provides a threaded portion 18 which is externally threaded to correspond to an internal thread that is to be machined by the tap 10. The threaded portion 18 consists of a chamfered portion 20 located in an extreme distal end of the tap 10, and a complete thread portion 22 contiguous to the chamfered portion 20 in an axial direction of the tap 10. The chamfered portion 20 is tapered by chamfering threads located in the chamfered portion 20, namely, by cutting away crests of the respective threads located in the chamfered portion 20. This tap 10 has a pair of cutting edges 24 each provided by a rear-side one of widthwise opposite edges of the corresponding flute 16 as viewed in a rotating direction of the tap 10. In the present embodiment, the number of threads (thread ridges) located in the chamfered portion 20 is about 1.5, namely, the number of chamfered threads (chamfered thread ridges) is about 1.5. It is noted that FIG. 1A is a perspective view of the tap 10 while FIG. 1B is a cross sectional view of the threaded portion 18 which is taken in a plane perpendicular to an axis of the tap 10.

The tap 10 is constituted by a substrate which is formed of powder metallurgy HSS (CPM). The threaded portion 18 is coated with a DLC (diamond-like carbon) coating such that not only the lands 17 but also the flutes 16 are covered by the DLC coating. The DLC coating is formed by a plasma CVD method, and has a thickness of 0.1-0.3 μm. It is noted that the DLC coating may be formed to cover not only the threaded portion 18 of the fluted main body 14 but also the other portion (non-threaded portion) of the fluted main body 14, as needed.

In the tap 10 constructed according to the present embodiment of the invention, the number of the chamfered threads (i.e., the number of the threads located in the chamfered portion) is so small as about 1.5 as counted along the axial direction of the tap 10. Therefore, in a cutting of an internal thread with the tap 10 in a work material, since the chamfered portion 20 of this tap 10 has a relatively small area, the internal thread is cut with the relatively small area being brought into contact with the work material.

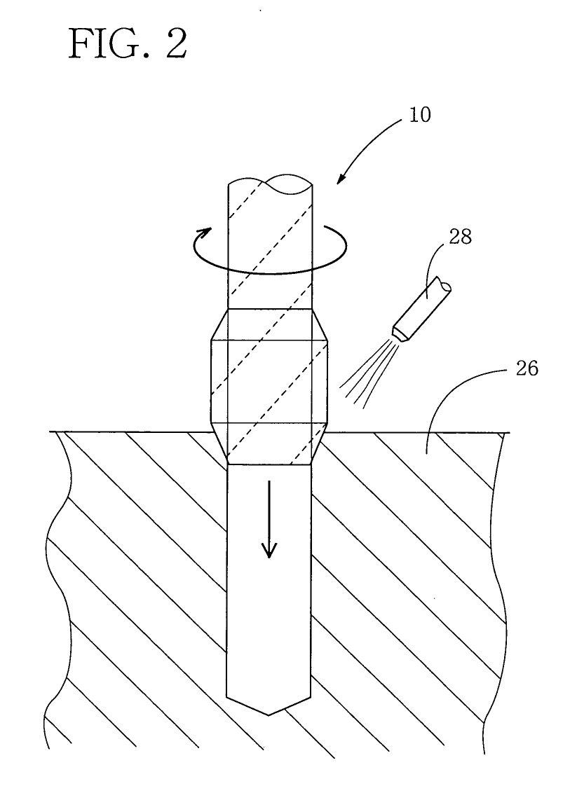

Further, in the present tap 10, the threaded portion 18 including the chamfered portion 20 and the complete thread portion 22 is coated with the DLC coating which has a small coefficient of friction. The provision of the DLC coating having the small coefficient of friction cooperates with the above-described arrangement in which the chamfered portion 20 has the relatively small area, to prevent chip material from adhering to each cutting edge of the tap 10 and accordingly extend the tool life, even where the tap 10 is used for machining an internal thread in an easily fusible or weldable work material with application of an air blow containing no lubricating oil or with application of an oil mist containing a minimum quantity of lubricating oil. Since the thickness of the DLC coating is so small as 0.1-0.3 μm, the DLC coating does not affect a cutting sharpness of each cutting edge 24, thereby assuring a satisfactory cutting performance of the tap 10. FIG. 2 schematically illustrates a threading operation with the tap 10 in which an internal thread is machined in a workpiece 26 made of an aluminum-based material. In this operation, the air blow or oil mist is ejected through a nozzle 28 of a machine tool (not shown) toward a machining point at which the workpiece 26 is machined by the tap 10, while at least one of the tap 10 and the workpiece 26 is rotated and moved relative to the other of the tap 10 and the workpiece 26.

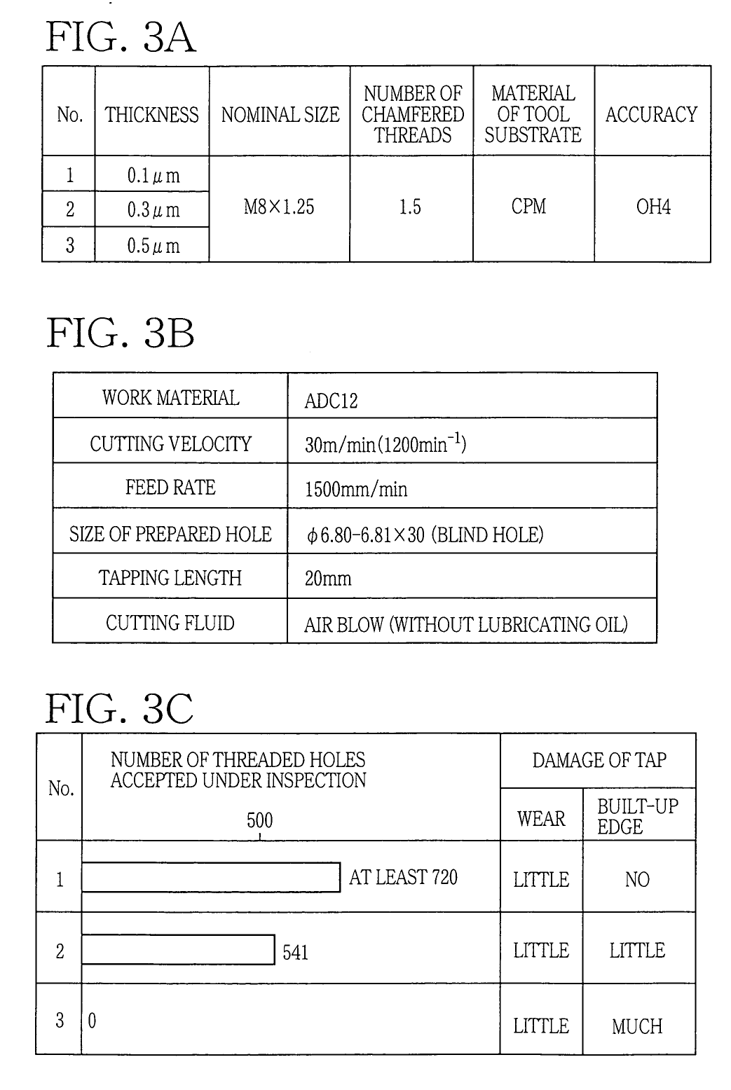

FIGS. 3A-3C show a durability test conducted by using three spiral-fluted taps Nos. 1-3 which are identical with each other except in thickness of DLC coating. The thickness of the DLC coating of the tap No. 1, that of the tap No. 2 and that of the tap No. 3 are 0.1 μm, 0.3 μm and 0.5 μm, respectively, as indicated in the table of FIG. 3A. In the test, internal threads were successively cut in a work material made of aluminum (ADC12) under a cutting condition, as specified in the table of FIG. 3B, for checking durability of each tap by seeing a number of the holes tapped successively without intolerable deterioration in the machining accuracy or without breakage of the tap. As shown in the graph of FIG. 3C, more than 500 holes were successively tapped in the tapping operation with the tap No. 1 and also in the tapping operation with the tap No. 2. Described specifically, in the tapping operation with the tap No. 1, it appeared that still more holes could be tapped by the tap No. 1 even when the 720th hole was tapped. In the tapping operation with the tap No. 2. the 541st tapped hole was the last tapped hole which was accepted under an inspection with a thread plug gauge. However, none of the tapped holes machined by the tap No.3 was not accepted under the inspection with the thread plug gauge. It was confirmed that a large amount of deposit of chip material adhered to each cutting edge of the tap No. 3. That is, the test revealed that the deposition of chip material on each cutting edge can not be satisfactorily prevented where the thickness of the DLC coating is larger than 0.4 μm.

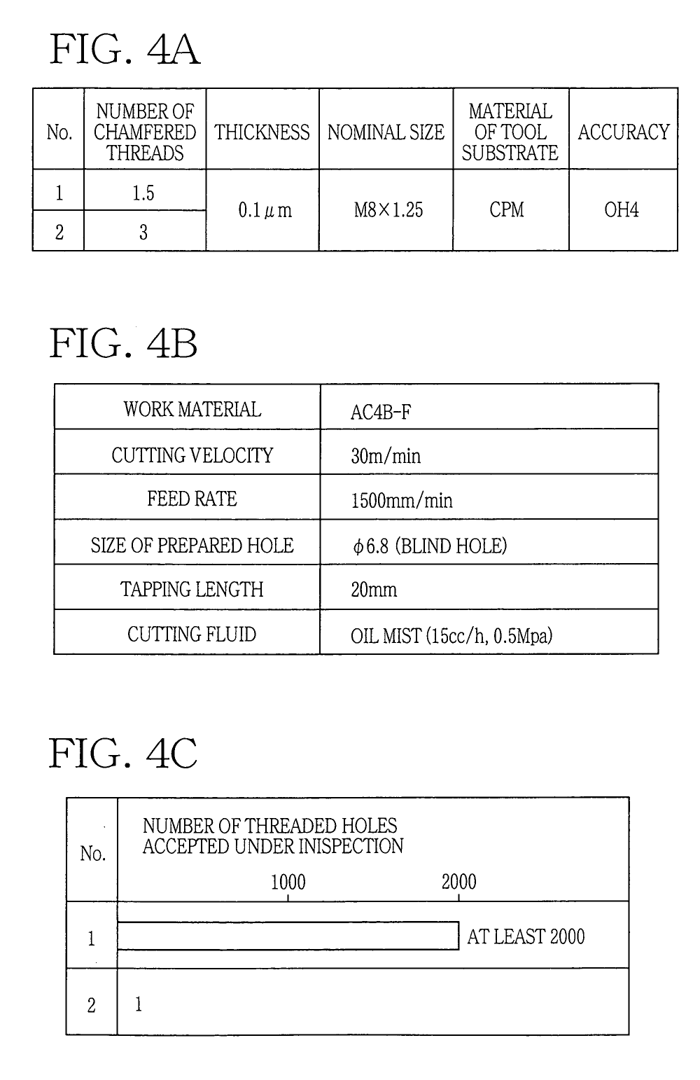

FIGS. 4A-4C show another durability test conducted by using two spiral-fluted taps Nos. 1 and 2 which are identical with each other except in number of chamfered threads. As indicated in the table of FIG. 4A, the number of chamfered threads is 1.5 in the tap No. 1, while the number of chamfered threads is 3.0 in the tap No. 2. In the test, internal threads were successively cut in a work material made of aluminum (AC4B-F) under a cutting condition as specified in the table of FIG. 4B. As shown in the graph of FIG. 4C, in the tapping operation with the tap No. 1, it appeared that still more holes could be tapped by the tap No. 1 even when the 2000th hole was tapped. However, only one of the tapped holes machined by the tap No. 2 was accepted under the inspection with the thread plug gauge. It was confirmed that a large amount of deposit of chip material adhered to each cutting edge of the tap No. 2. That is, the test revealed that the deposition of chip material on each cutting edge can not be satisfactorily prevented where the number of the chamfered threads is not smaller than 3.0.

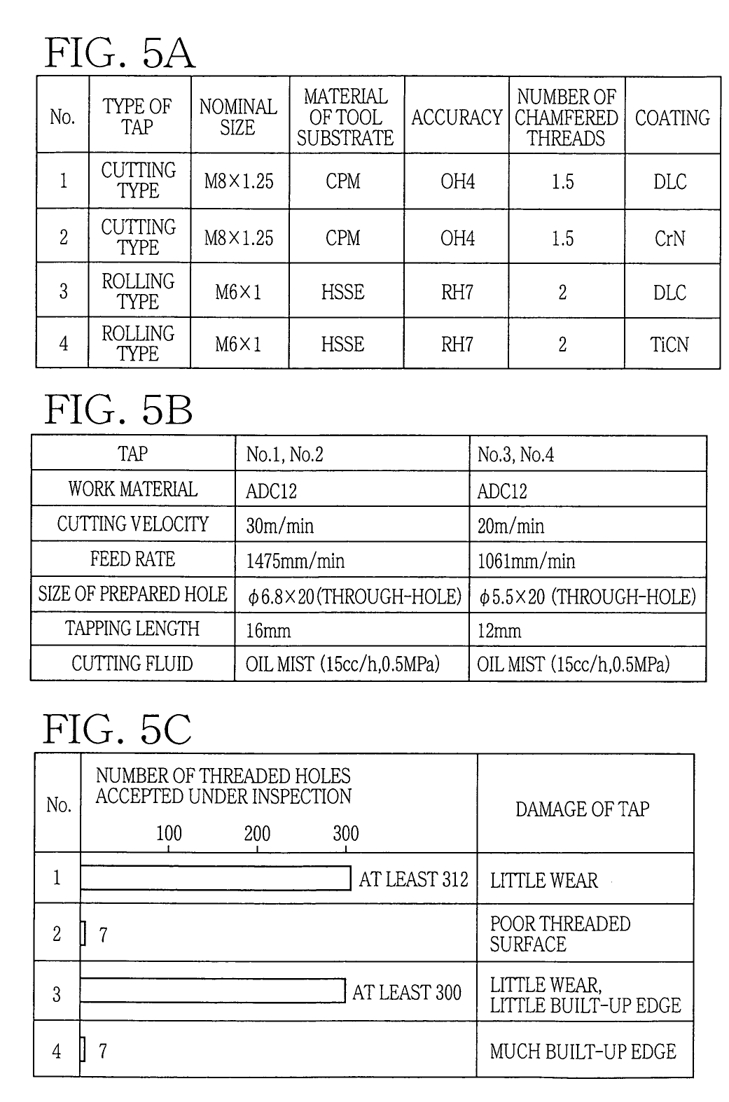

FIGS. 5A-5C show still another durability test conducted by using two spiral-fluted taps (cutting-type taps) Nos. 1 and 2 and two flute-less taps (cold-forming or rolling type taps) Nos. 3 and 4. The spiral-fluted taps Nos. 1 and 2 are identical with each other except in material of coating. The tap No. 1 is coated with a DLC coating having a thickness of 0.1 μm, while the tap No. 2 is coated with a CrN coating having a thickness of 0.1 μm. Similarly, the flute-less taps Nos. 3 and 4 are identical with each other except in material of coating. The tap No. 3 is coated with a DLC coating having a thickness of 0.1 μm, while the tap No. 4 is coated with a TiCN coating having a thickness of 0.1 μm. In the test, internal threads were successively cut in a work material made of aluminum (ADC12) under a cutting condition as specified in the table of FIG. 5B. As shown in the graph of FIG. 5C, in each of the tapping operations with the taps No. 1 and No. 3, it appeared that still more holes could be tapped by the respective taps even when the 312th or 300th hole was tapped. However, in each of the tapping operations with the taps No. 2 and No. 4, the tap was no longer usable when the 7th hole was tapped. Thus, the test revealed that the DLC coating serves to remarkably reduce a friction generated between the tap and the work material, thereby minimizing an amount of deposit of chip material adhering to each cutting edge of the tap and improving a smoothness of the threaded surface of the work material. That is, the test revealed that the tap coated with the DLC coating is provided with a longer tool life, than the tap coated with the CrN coating or TiCN coating.

While the presently preferred embodiment of the present invention has been illustrated above, it is to be understood that the invention is not limited to the details of the illustrated embodiment, but may be embodied with various other changes, modifications and improvements, which may occur to those skilled in the art, without departing from the spirit and scope of the invention defined in the following claims.

What is claimed is:

1. A tap having a threaded portion which includes:
a chamfered portion provided by an axially distal end portion of said tap; and
a complete thread portion contiguous to said chamfer portion in an axial direction of said tap,
wherein a number of chamfered threads is not larger than 2.5 as counted along said axial direction,
and wherein said threaded portion is coated with a diamond-like carbon coating which has a thickness of not larger than 0.4 μm.

2. A tap according to claim 1, consisting of a spiral-fluted tap having spiral flutes.

3. A tap according to claim 1, wherein said number of chamfered threads is 1.5-2.0 as counted in said axial direction.

4. A tap according to claim 1, wherein said thickness of said diamond-like carbon coating is not smaller than 0.05 μm.

5. A tap according to claim 1, wherein said thickness of said diamond-like carbon coating is 0.1-0.3 μm.

6. A process of machining an internal thread in a workpiece made of a material including aluminum, by using the tap defined in claim 1, said process comprising:
a step of applying an air blow toward a machining point at which said workpiece is machined by said threaded portion of said tap, while at least one of said tap and said workpiece is rotated and moved relative to the other of said tap and said workpiece.

7. A process of machining an internal thread in a workpiece made of a material including aluminum, by using the tap defined in claim 1, said process comprising:
a step of applying an oil mist toward a machining point at which said workpiece is machined by said threaded portion of said tap, while at least one of said tap and said workpiece is rotated and moved relative to the other of said tap and said workpiece.
